(19) United States
(12) Patent Application Publication
(10) Pub. No.: US 2026/0280377 A1
(43) Pub. Date: Sep. 17, 2026

(54) Multi-Part Cover Element for Covering a Winding Head of a Rotor

(71) Applicant: Bayerische Motoren Werke Aktiengesellschaft, Muenchen (DE)

(72) Inventors: Maximilian HALLWEGER, Dachau (DE); Philipp JACOB, Kirchheim (DE)

(21) Appl. No.: 19/567,753

(22) Filed: Mar. 16, 2026

(30) Foreign Application Priority Data
Mar. 17, 2025 (DE) 10 2025 110 132.9

(51) Int. Cl. H02K 5/15; H02K 1/24; H02K 5/10

(52) U.S. Cl. CPC H02K 5/15; H02K 1/24; H02K 5/10

(57) ABSTRACT

A cover element for a rotor of an electric machine is configured to cover a winding head arranged on an end face of a rotor body of the rotor, and wherein the cover element has a support part and an insulation part. The insulation part is configured to be arranged along the axial direction between the end face of the rotor body and the support part. Furthermore, the insulation part has N recesses for corresponding N winding head portions of the winding head. The support part is designed to cover the insulation part in such a way that a fluid-tight cavity for receiving potting compound is formed between the insulation part and the support part.

### CROSS-REFERENCE TO RELATED APPLICATION

This application claims priority under 35 U.S.C. § 119 from German Patent Application No. 10 2025 110 132.9, filed Mar. 17, 2025, the entire disclosure of which is herein expressly incorporated by reference.

### BACKGROUND AND SUMMARY

The invention relates to an electric machine, such as a (current-excited) synchronous machine. In particular, the invention relates to a front cover element for covering a front side of a rotor.

A vehicle that is at least partially electrically driven comprises an electric machine for driving the vehicle. The electric machine comprises a stator that encloses a rotor of the electric machine, wherein a current-excited rotor has a rotor body with rotor slots in which electrically conductive windings are arranged for generating a magnetic field. The windings of the rotor form a winding head at each end face of the rotor, wherein the windings can be supported by a star disk arranged at the respective end face. A cover element for covering the respective winding head can be attached, in particular screwed on, at each end face.

The present document deals with the technical problem of providing a particularly efficient cover element for covering and/or cooling an end face of a rotor.

The problem is solved by the present disclosure. Advantageous embodiments are also described, inter alia, herein. It should be noted that additional features of a patent claim dependent on an independent patent claim, without the features of the independent patent claim or only in combination with a subset of the features of the independent patent claim, may constitute a separate invention independent of the combination of all features of the independent patent claim, which may be the subject of an independent claim, a divisional application or a subsequent application. This applies equally to technical teachings described in the description, which may constitute an invention independent of the features of the independent patent claims.

According to one aspect, a cover element for a rotor of an electric machine is described, wherein the cover element is designed to cover the winding head arranged on an end face of the rotor body of the rotor. The cover element comprises a support part and an insulation part. The insulation part may consist of an electrically insulating material, in particular a plastic. The support part may consist of a metal, in particular a metal plate.

The insulation part and the support part may each have a surface that runs substantially perpendicular to the axial direction (i.e., to the axis of rotation of the rotor body and/or to the rotor shaft of the rotor) when the cover element is arranged on the end face of the rotor body. The surfaces of the insulation part and the support part may each have a substantially circular outer edge. Furthermore, the surfaces of the insulation part and the support part may each have a radius (up to the outer edge) in the radial direction that substantially corresponds to the radius of the rotor body. The surfaces of the insulation part and the support part may each have a central (circular) recess for receiving the rotor shaft of the rotor.

The insulation part is designed to be arranged along the axial direction between the front side of the rotor body and the support part. The support part is designed to cover the insulation part in such a way that a fluid-tight cavity for receiving potting compound is formed between the insulation part and the support part. For this purpose, the insulation part may have a circumferential (ring-shaped) sealing element on the outer edge extending in the circumferential direction and on the front side facing the support part for sealing the cavity formed between the insulation part and the support part. The cavity can be designed to accommodate potting compound. The support part can have one or more openings (within the surface of the support part) through which potting compound can be introduced into the cavity formed between the insulation part and the support part.

The insulation part further comprises N recesses for corresponding N winding head portions of the winding head, with N≥3, for example N≥4 or N≥6. The N recesses are preferably each designed such that
(exactly) one winding head portion of the winding head extends in the axial direction through each of the N recesses into the cavity formed between the insulation part and the support part when the cover element is arranged on the front side of the rotor body; and/or
the individual winding head portions of the winding head are each in direct contact with potting compound when the cavity formed between the insulation part and the support part is filled with potting compound.

The N recesses may be arranged evenly around the circumference of the axis of rotation of the rotor body. Furthermore, the N recesses may each be formed as (completely) separate recesses in the (base) surface of the insulation part.

By providing a multi-part cover element with recesses for the individual winding head portions of the winding head of a rotor, a particularly efficient and reliable covering and cooling of the winding head of the rotor can be achieved.

The insulation part may have a sealing element extending circumferentially on the rear side facing the rotor body for sealing the gap between the cover element and the front side of the rotor body, in particular the gap between the cover element and the star disk arranged on the front side of the rotor body. In this way, a cavity for receiving potting compound can be formed in a particularly reliable manner on the front side of the rotor body.

The cover element may have M holes through the support part and through the insulation part, which enable the cover element to be fastened to the front side of the rotor body using M screws running in the axial direction, with M≥2, in particular M≥3 (in particular to be screwed on). The insulation part may have M sleeves for the corresponding M screws on the rear side facing the rotor body. The individual sleeves may each extend from the rear side of the insulation part in the axial direction toward the front side of the rotor body. This allows the cover element to be fixed to the front side of the rotor body in a particularly efficient and reliable manner.

According to a further aspect, a rotor for an electric machine, in particular for a (current-excited) synchronous machine, is described. The rotor comprises a rotor body, which typically has a plurality of rotor slots, each of which extends in the axial direction from a first end face to an opposite second end face of the rotor body. The rotor body may have, for example, N=4 or more, or N=6 or more rotor slots. The individual rotor slots may each be arranged between two leg poles of the rotor body. The individual leg poles may extend in the radial direction away from the yoke of the rotor body. A central recess for the rotor shaft of the rotor may be arranged in the yoke of the rotor body. The rotor shaft extends in the axial direction.

The rotor may have a first star disk adjacent to the first end face and a second star disk adjacent to the second end face, wherein the star disks each have M threaded holes, with M≥2, in particular M≥3 or M≥6. The star disks may each have a yoke region that is adjacent to the yoke of the rotor body. Furthermore, the star disks may each have a leg region for the individual leg poles of the rotor body, wherein the leg regions extend radially away from the yoke region of the respective star disk.

The rotor further comprises electrically conductive windings, typically arranged in the rotor slots, which windings form a winding head (with N winding head portions in each case) on the respective end face, in particular on the respective star disk.

Furthermore, the rotor comprises at least one cover element which is designed as described in this document and which covers the winding head arranged on the first end face or the second end face. In particular, the rotor may have a cover element covering the respective winding head on both end faces.

According to a further aspect, an electric machine, in particular a (current-excited) synchronous machine, is described which comprises the rotor described in this document. Furthermore, the electric machine typically comprises a stator.

According to a further aspect, a (road) motor vehicle (in particular a passenger car or a truck or a bus or a motorcycle) is described which comprises the electric machine described in this document for driving the vehicle.

It should be noted that the devices and systems described in this document can be used both alone and in combination with other devices and systems described in this document. Furthermore, any aspects of the devices and systems described in this document can be combined with each other in a variety of ways. In particular, the features disclosed herein can be combined with each other in a variety of ways. Furthermore, features listed between parentheses are to be understood as optional features.

The invention is described in more detail below with reference to exemplary embodiments.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1a shows an exemplary electric machine;

FIG. 1b shows a perspective view of an exemplary rotor body;

FIG. 1c shows a perspective view of an exemplary slot closure wedge;

FIG. 2a shows a perspective view of an exemplary rotor with rotor windings;

FIG. 2b shows an exemplary support ring;

FIG. 3a shows a perspective view of an exemplary cover element; and

FIG. 3b shows a schematic representation of an outer edge of the cover element from FIG. 3a.

### DETAILED DESCRIPTION OF THE DRAWINGS

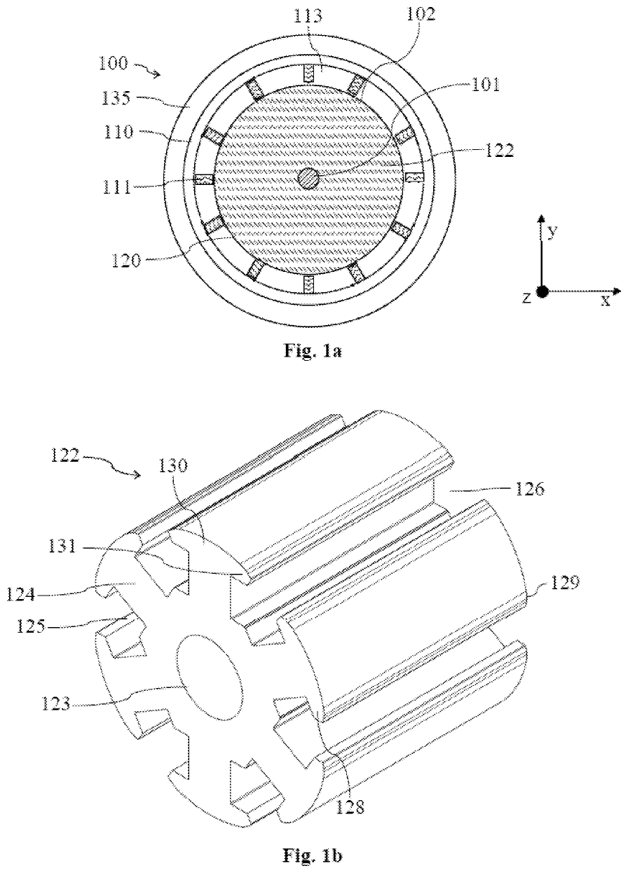

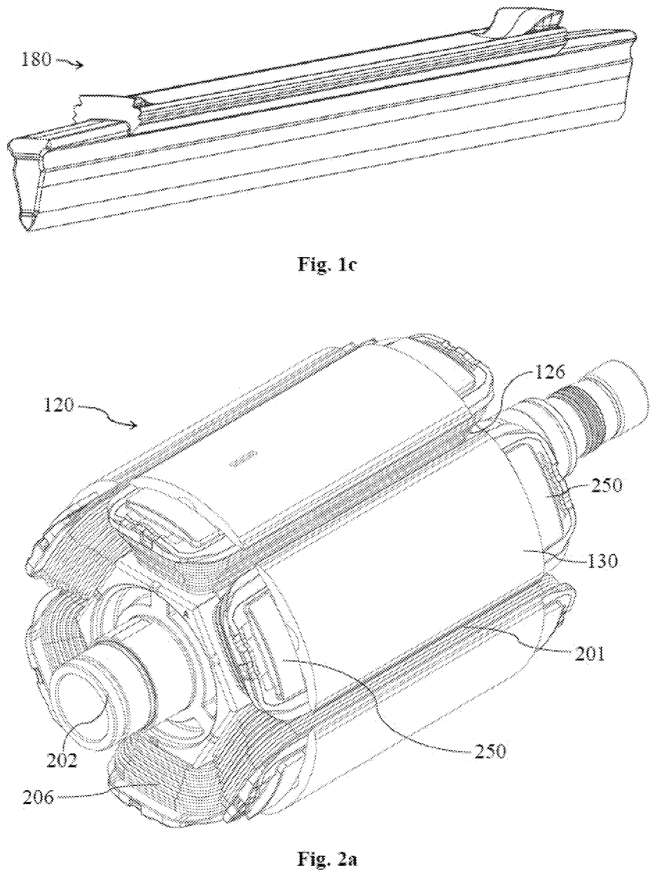

As explained at the outset, this document deals with the efficient and reliable covering and/or cooling of an end face of a rotor of an electric machine. In this context, FIG. 1a shows an example of an electric machine 100 in a view perpendicular to the shaft 101 of the electric machine 100. The shaft 101 of the electric machine 100 may correspond to the longitudinal axis of the stator 110 and/or the axis of rotation of the rotor 120 of the electric machine 100. Furthermore, the shaft 101 may extend along the z-axis of the Cartesian coordinate system shown.

The electric machine 100 comprises a stator 110 with a plurality of stator windings 111, which are arranged at different angular positions around the axis of rotation of the rotor 120 and are designed to generate an electromagnetic rotating field. The stator 110 is surrounded by a housing 135 of the electric machine 100.

Furthermore, the electric machine 100 comprises the rotor 120, which is driven by the rotating field produced by the stator 110. The rotor 120 is firmly connected to the shaft 101 driven by the electric machine 100 (which may be connected to the rotor shaft of the rotor 120 or correspond to the rotor shaft of the rotor 120). The rotor 120 comprises a rotor body 122.

The rotor 120 of an electric machine 100 may have an iron laminated core (e.g., composed of mutually insulated laminations) as the rotor body 122. FIG. 1b shows an exemplary rotor body 122 of a rotor 120 in a perspective view. The rotor body 122 extends along the axis of rotation or the longitudinal axis of the rotor 120 (i.e., in the axial direction) from a first end face 128 to an opposite second end face 129. In the example shown, the rotor body 122 has different magnetic leg poles 124, which are arranged at different angular positions around the axis of rotation of the rotor 120. The leg poles 124 can be arranged evenly around the axis of rotation. A rotor coil (i.e., windings) can be arranged around each of the individual leg poles 124, through which a magnetic field is generated. The individual leg poles 124 can thus form magnetic poles of the rotor 120.

The rotor body 122 has a central opening 123, in particular a hole, into which the rotor shaft of the rotor 120 can be inserted. The rotor shaft can be rotatably mounted on the end faces of the rotor body 122 via respective bearing surfaces to enable rotation of the rotor 120.

A rotor slot 125 is formed between each pair of directly adjacent pole legs 124 of the rotor body 122, in which rotor slots the windings of the adjacent pole legs 124 are arranged. A rotor slot 125 extends along the longitudinal and/or rotational axis from the first end face 128 to the opposite second end face 129 of the rotor body 122.

The rotor slot 125 between two (in the circumferential direction) directly adjacent leg poles 124 has an opening 126 on the outer surface of the rotor body 122 facing away from the rotor shaft, wherein the opening 126 extends along the longitudinal axis from the first end face 128 to the second end face 129 of the rotor body 122. In the transverse direction to the longitudinal axis, the opening 126 is bounded by (facing) legs 131 of the pole shoes 130 of the two directly adjacent leg poles 124.

To manufacture a rotor 120, electrically conductive windings can be wound around the leg poles 124 so that windings of the two directly adjacent leg poles 124 are arranged in a rotor slot 125. After arranging the windings, the openings 126 of the individual rotor slots 125 can be covered with a slot closure wedge 180 (see FIG. 1 c). A slot closure wedge 180 can be pushed in from an end face 128 between the legs 131 of the pole shoes 130 of the two directly adjacent leg poles 124 in order to cover the opening 126.

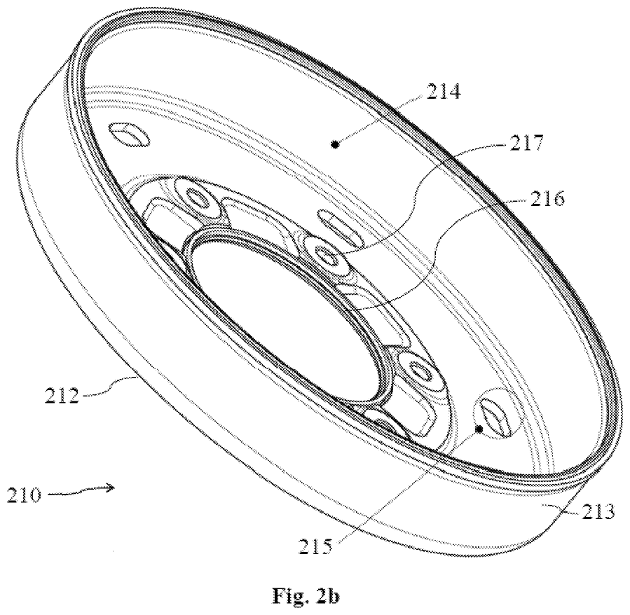

FIG. 2a shows a perspective view of a rotor 120 with a rotor body 122, wherein a rotor shaft 202 is arranged in the central opening 123 of the rotor body 122. Furthermore, rotor windings 201 are arranged around each of the individual pole legs 124. The rotor windings 201 form a winding head 206 on each of the two end faces 128, 129 of the rotor body 122. The openings 126 of the individual rotor slots 125 to be covered can be seen between the pole shoes 130 of the individual leg poles 124.

During operation of the electric machine 100, centrifugal forces act on the rotor 120, in particular on the winding heads 206 on the two end faces 128, 129 of the rotor body 122, in a radial direction, which could lead to damage to the electric machine 100, in particular to the windings 201. To absorb the forces acting on the winding heads 206, a pot-shaped support ring 210 can be arranged on each of the end faces of the rotor 120 (see FIG. 2b). The support ring 210 has a cover region 212 that runs substantially parallel to the respective end face and covers the respective end face in the axial direction. The cover region 212 has a central, circular recess 216 through which the shaft 202 of the rotor 120 is guided.

The support ring 210 also has an annular edge region 213 which extends in the axial direction away from the outer edge of the cover region 212 towards the rotor body 122. The edge region 213 has an inner surface 214 which, when the support ring 210 is installed, can rest, for example, on bearing regions of the star disk 250 of the rotor 120 (in order to fix the support ring 210 to the rotor body 122). The star disk 250 can rest against the end face 128, 129 of the rotor body 122. The individual bearing regions can be formed by the outer surface of the star disk 250.

During assembly, a support ring 210 can be pushed onto the bearing regions of the respective star washer 250 in the axial direction on both front sides of the rotor 120, so that the winding heads 206 on both front sides of the rotor 120 are each covered by a support ring 210 (in the axial direction and in the radial direction).

A support ring 210 can be fixed in place via a press fit between the support ring 210 and the star washer 250, in particular between the edge region 213 of the support ring 210 and the outer surface of the star washer 250. In order to also ensure axial fixation, the support ring 210 can be screwed into the star disk 250. For this purpose, the support ring 210, in particular the cover region 212 of the support ring 210, may have one or more holes 217 through which a screw can be inserted to fix the support ring 210 to the star disk 250.

The star disk 250 itself can be fixed to the rotor body 112 via the respective winding head 206 and/or via a press fit between the star disk 250 and the rotor shaft 202.

The support ring 210 may be formed in several parts if necessary. In particular, the edge region 213 may be designed as a bandage, and the cover region 212 may be designed as a (substantially flat) cover element.

The support ring 210 may also have one or more openings 215 through which potting compound can be introduced into the cavity between the support ring 210 and the star disk 250 and/or the end face 128, 129 of the rotor body 122 in order to support the winding head 206.

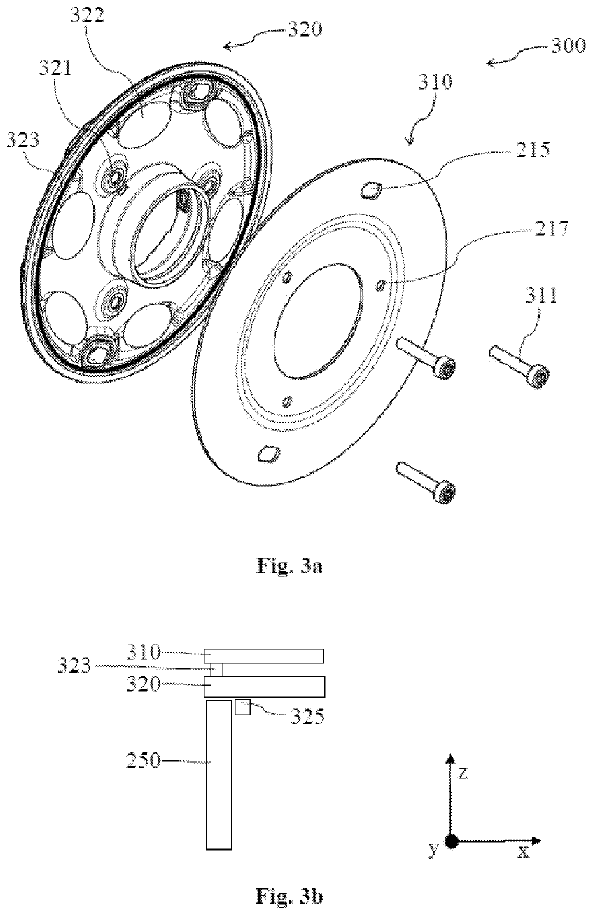

FIG. 3a shows a multi-part cover element 300 for covering an end face of a rotor 120. The cover element comprises an insulation part 320 and a support part 310. The insulation part 320 can be arranged between the support part 310 and the end face 128, 129 of the rotor body 122. The insulation part 320 has N recesses 322 in which the winding head portions of the winding head 206 formed on each of the N leg poles 124 can be arranged. Furthermore, the insulation part 320 comprises a sealing element 323 on the outer edge running in the circumferential direction for sealing the cavity formed between the insulation part 320 and the support part 310. The insulation part 320 preferably consists of an electrically insulating material, such as plastic.

The insulation part 320 also comprises tubular sleeves 321, each of which is designed to accommodate a screw 311 for axially fixing the cover element 300 to the end face 128, 129 of the rotor body 122. The individual sleeves 321 are each arranged in axial alignment with a hole 217 in the support part 310.

The insulation part 320 may also have a further sealing element 325 (see FIG. 3b) on the rear side facing the rotor body 122, which provides a seal between the star disk 250 and the cover element 300.

The support part 310 is preferably made of a metal, e.g., steel or aluminum.

To mount the cover element 300, the insulation part 320 can first be placed on an end face 128, 129 of the rotor body 122 and on the winding head 206 arranged on this end face 128, 129. The insulation part 320 can then be covered with the support part 310. The cover element 300 can be fixed in place using screws 311, which are inserted through the individual holes 217 in the support part 310 and through the sleeves 321 of the insulation part 320, and which are screwed into corresponding threaded holes in the end face 128, 129 of the rotor body 122. Finally, potting compound can be introduced through the openings 215 of the support part 310 into the cavity between the insulation part 320 and the support part 310 in order to fix the winding head 206. The potting compound ensures reliable dissipation of the waste heat from the winding head 206.

A cover element 300 is thus described, which has a plastic cover (i.e., an insulation part) 320 (with sleeves 321 and sealing elements 323, 325) and a steel plate (i.e., a support part) 310 to provide strength. The plastic cover 320 has a recess 322 in the region of each of the individual winding head portions of the winding head 206. As a result, the potting compound applied to the front side extends in the axial direction directly from the winding head 206 to the steel plate 310, thereby improving axial heat dissipation. Furthermore, the recesses 322 enable a relatively efficient and reliable potting process.

The present invention is not limited to the exemplary embodiments shown. In particular, it should be noted that the description and figures are intended merely to illustrate the principle of the proposed devices and systems.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1) A cover element for a rotor of an electric machine,
wherein the cover element is configured to cover a winding head arranged on an end face of a rotor body of the rotor,
wherein the cover element comprises:
a support part; and
an insulation part,
wherein the insulation part is configured to be arranged along an axial direction between the end face of the rotor body and the support part,
wherein the insulation part has N recesses for corresponding N winding head portions of the winding head, and
wherein the support part is configured to cover the insulation part so that a fluid-tight cavity for receiving potting compound is formed between the insulation part and the support part.

2) The cover element according to claim 1,
wherein the insulation part comprises a sealing element extending circumferentially on a circumferential outer edge and on a front side facing the support part configured to seal the cavity formed between the insulation part and the support part.

3) The cover element according to claim 1,
wherein the insulation part comprises a circumferential sealing element on a rear side facing the rotor body configured to seal a gap between the cover element and the end face of the rotor body between the cover element and a star disk arranged on the end face of the rotor body.

4) The cover element according to claim 1,
wherein the insulation part comprises an electrically insulating material, and/or
wherein the support part comprises a metal plate.

5) The cover element according to claim 1,
wherein the N recesses are each designed such that:
a winding head portion of the winding head extends in the axial direction into the cavity formed between the insulation part and the support part with the cover element arranged on the end face of the rotor body; and
the individual winding head portions of the winding head are each in direct contact with the potting compound that is filled in the cavity formed between the insulation part and the support part.

6) The cover element according to claim 1,
wherein the N recesses are arranged in a circumferential direction uniformly distributed about a rotational axis of the rotor body, and/or
wherein the insulation part has a base surface that is arranged perpendicular to the axial direction, and the N recesses are each formed as separate recesses in the base surface.

7) The cover element according to claim 1,
wherein the cover element has M holes through the support part and through the insulation part, which M holes are configured to enable the cover element to be fastened by M axially extending screws to the front side of the rotor body, wherein M is greater than 2.

8) The cover element according to claim 7,
wherein the insulation part has M sleeves for the corresponding M screws on a rear side facing the rotor body, and
wherein the sleeves each extend from the rear side of the insulation part in the axial direction toward the front side of the rotor body.

9) The cover element according to claim 1,
wherein the support part comprises one or more openings through which the potting compound is introduced into the cavity formed between the insulation part and the support part.

10) A rotor for an electric machine, the rotor comprising:
a rotor shaft extending in an axial direction;
a rotor body with N rotor slots, each of which extends in the axial direction from a first end face to an opposite second end face of the rotor body;
electrically conductive windings arranged in the N rotor slots, which windings form a winding head at each of the first and second end faces of the rotor body; and
the cover element according to claim 1 and which covers the winding head arranged on the first end face or the second end face.
